(19) United States
(12) Patent Application Publication
(10) Pub. No.: US 2004/0059874 A1
(43) Pub. Date: Mar. 25, 2004

(54) High throughput modular pipelined memory array

(75) Inventors: Robert James Murray, Portland, OR (US); Mark Duanne Nardin, Beaverton, OR (US)

Correspondence Address: Julie L. Reed, MARGER JOHNSON & McCOLLOM, P.C., 1030 S.W. Morrison Street, Portland, OR, 97205, US

(73) Assignee: Intel Corporation, Santa Clara, CA

(21) Appl. No.: 10/254,190

(22) Filed: Sep. 24, 2002

(51) Int. Cl. G06F 12/00

(52) U.S. Cl. 711/138; 711/169

(57) ABSTRACT

A memory architecture is disclosed. A memory device may comprise at least two memory blocks electrically coupled in a pipelined manner. Each block may comprise a memory array, and a bypass network. A system may include several memory blocks coupled together in a pipelined manner electrically coupled to at least two functional units.

### BACKGROUND

1. Field

This disclosure relates to pipelining, more particularly to pipelining in memory arrays.

2. Background

High-speed memory arrays, sometimes referred to as register files, typically require many ports that must be operational at the same time. As higher-level designs evolve, the register files must have more ports. However, the register files grows in two dimensions for each port. The larger the files grow, the slower they operate.

These register files may be used with microprocessors, digital signal processors or any other type of data flow machines that operate at very high speeds. These data flow machines have source and results, where the sources are the operands that functional units in the data flow operate upon. The results are produced from the functional units after they perform their operations. Some results then become operands. These results that become operands, referred to as dependent results, are often stored in the register file. Therefore, the speed of the register file affects the speed of the overall machine.

Some solutions to the size and speed of the register file have been proposed. An approach directed to increasing the speed of the register file can be found in U.S. Pat. No. 6,000,016, “Multiported Bypass Cache in a Bypass Network.” An approach to managing the size of the register file with memory pipelining can be found in U.S. patent application Ser. No. 09/764,250, Publication No. US 2002/0095555.

### BRIEF DESCRIPTION OF THE DRAWINGS

The invention may be best understood by reading the disclosure with reference to the drawings, wherein:

FIG. 1 shows an embodiment of a pipelined register file.

FIG. 2 shows an embodiment of a memory block usable in a pipelined register file.

FIG. 3 shows an embodiment of a system employing a pipelined register file.

FIG. 4 shows an embodiment of a timing diagram for a pipelined register file.

### DETAILED DESCRIPTION OF THE EMBODIMENTS

High-speed memory arrays, also referred to here as register files, usually require many ports to be operational at the same time. With the advent of superscalar designs, the register files must have more ports and more entries. However, this causes a two-dimensional growth, resulting in a very large, and therefore slower than desired, register file. However, it is possible to break up the large register file into smaller memory blocks and use pipelining to achieve size expansion without a corresponding speed decrease.

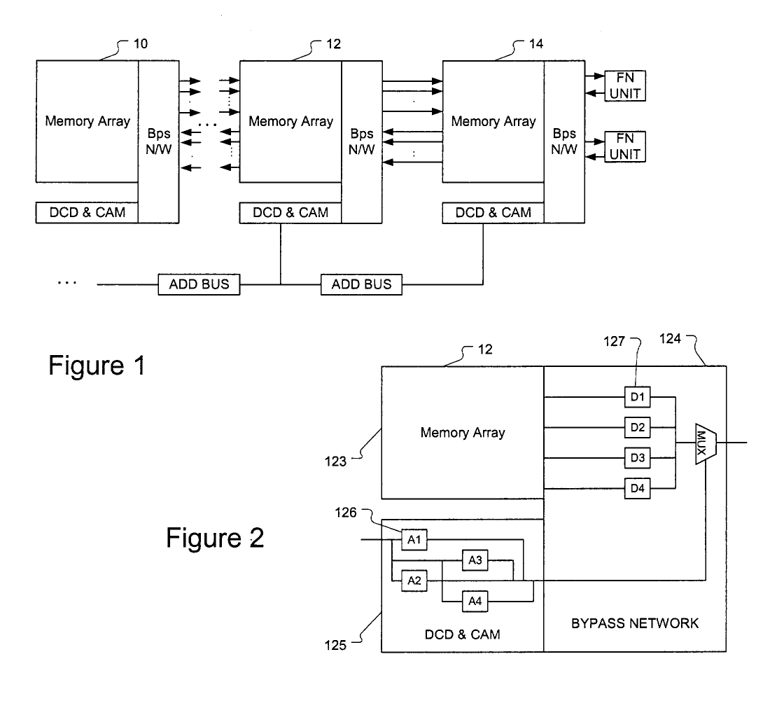

As can be seen in FIG. 1, a register file can be established as an array of memory blocks. Each memory block, such as blocks 10, 12 and 14, each have a memory array, a bypass network, a decoder and content addressable memory and bit lines that are electrically coupled to the adjacent blocks or to functional units. A functional unit is any device, such as a microprocessor, digital signal processor or other data flow machine. The bit lines may be used to stage the pipelined read data and the write data lines may be used to stage the pipelined write data from the functional units to the memory arrays. Each memory block is a complete pipeline stage that is self-contained.

FIG. 2 shows a more detailed view of an embodiment of a memory block. The memory block 12 has a memory array 123, which is the array of memory cells analogous to the register file memory cells. Essentially, each memory block is a small part of the overall register file, as a register file would have been used in previous memory systems. The memory block 12 also includes an address decoder and content-addressable memory 125 and bypass network 124.

The bypass network may allow faster access to the data in the memory block, depending upon the contents of the data registers 127. As described in U.S. Pat. No. 6,000,016, “Multiported Bypass Cache in a Bypass Network,” data may be written into the bypass network data registers 124, with the associated address written into the address registers 126 of the content-addressable memory (CAM). This is in addition to the writing of the data to the associated address in the memory array 123. The combination of data registers and address registers may be referred to here as the bypass network, even though the CAM may reside with the address decoder.

When an address is received on the address bus, the address registers in the CAM are matched to determine if any of the address registers have a match for that address. If they do have a match, the data register electrically coupled to that address register contains the desired data. If no match exists, the data is accessed from the appropriate address location in the memory array 123. This is just one embodiment of a bypass network, and no limitations on the actual implementation should be implied from this example.

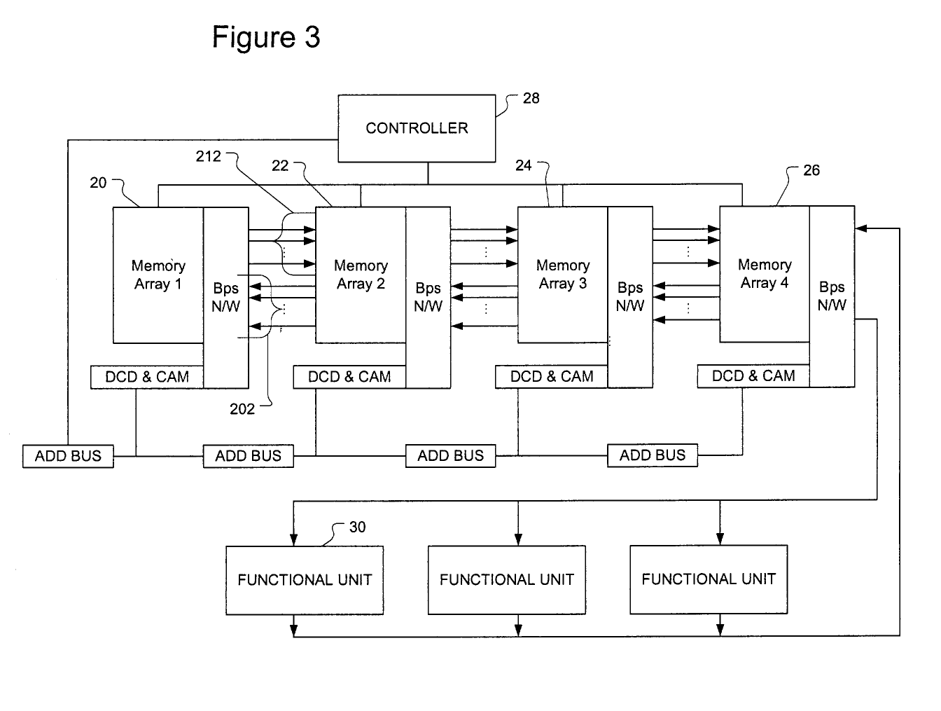

In this manner, dividing up the register file into discrete memory blocks that are arranged in a pipelined fashion allows an increase in the size of the overall register file without the corresponding delays. The system may be extensible to any size register file, with a small overhead for calculating the bypass cases for each block. As mentioned previously, the bit lines of each block may be used to stage pipelined read data and the write data lines may be used to stage pipelined write data. The write data may be directed back to the bypass network and the memory arrays from the functional units. This is shown in more detail in the example of FIG. 3.

For example, assume a functional unit such as 30 is an arithmetic logic unit (ALU) and will perform an addition of two operands. One of the operands is in memory block 1, 20 and the other is in memory block 4, 26. The controller puts the addresses on the address bus to be processed by each memory block in sequence. After the first operand passes out of memory block 4 and is staged on the read lines for block 3 at the same time as the address for the second operand is passed from block 4 to block 3. It must be noted that the controller 28 is shown as a separate entity, but will more than likely be a scheduling function of a system processor or other functional unit and may actually be part of the processor upon which the ALU function unit 30 resides.

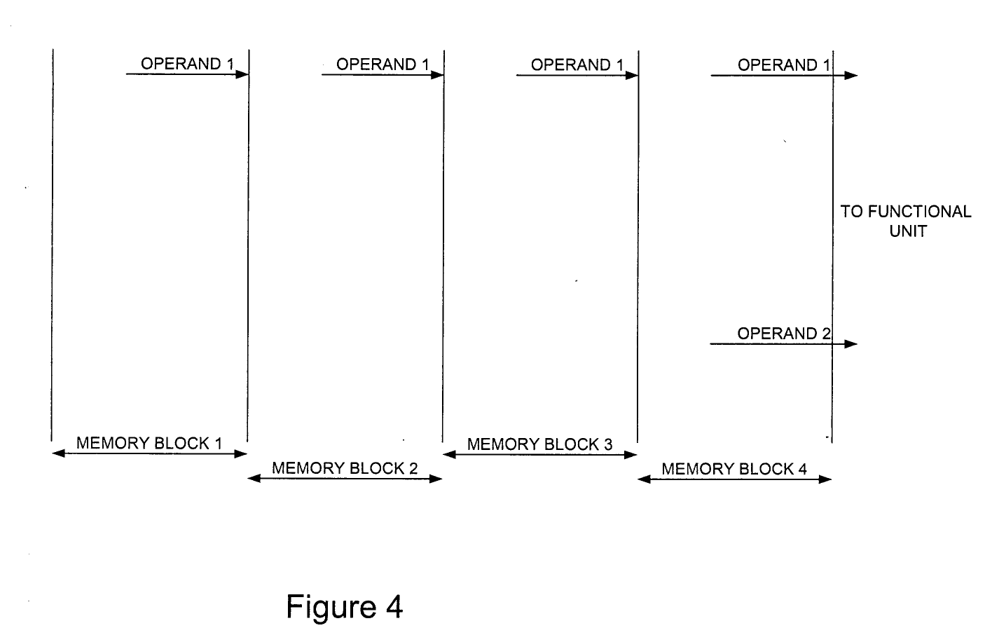

As mentioned previously, the bit lines 212 of memory block 1 may be used to stage the read pipeline data and the word lines 202 may be used to stage the write pipeline data. Referring to FIG. 4, it can be seen that OPERAND 1 will be staged from memory block 1 on the first cycle. During the subsequent two cycles OPERAND 1 will pass along the pipeline through memory blocks 2 and 3. After the final stage of the pipeline at memory block 1, OPERAND 1 and OPERAND 2 are available to the functional unit. The two operands are then available to the functional unit at the same time, allowing the functional unit to perform the necessary operation.

The pipeline is implemented by sequential organization of the memory blocks and by associating bypass networks with the functional units. In employing pipelining in the memory there is no extra dependent latency induced within the loop from the result to a dependent source as a result of the modular inclusion of the bypass multiplexer. There is an additional latency paid in the address to delivery of the source to the functional unit.

Thus, although there has been described to this point a particular embodiment for a method and apparatus for a high-speed pipelined memory, it is not intended that such specific references be considered as limitations upon the scope of this invention except in-so-far as set forth in the following claims.

What is claimed is:

1. A device, comprising:
at least two memory blocks electrically coupled in a pipelined manner, wherein each block comprises:
a memory array; and
a bypass network.

2. The device of claim 1, wherein each memory block further comprises a decoder electrically coupled to the address bus.

3. The device of claim 2, wherein the memory further comprises a content-addressable memory electrically couple to the decoder.

4. The device of claim 1, wherein bit lines in each memory block are to stage pipeline data between the memory blocks.

5. The device of claim 1, wherein the bypass network further comprises:
at least two data registers;
at least two address registers; and
a bypass multiplexer.

6. The device of claim 1, wherein the device includes at least one function unit to perform operations on operands stored in the memory blocks.

7. A memory block, comprising:
a memory array;
a bypass network electrically coupled to the memory array;
at least one bit-line electrically coupled to the bypass network, wherein the bit-lines are electrically couple to bit-lines of an adjacent memory block.

8. The memory block of claim 7, wherein the memory block further comprises a decoder electrically coupled to the bypass network.

9. The memory block of claim 7, wherein the memory block further comprises a content-addressable memory electrically couple to the decoder.

10. The memory block of claim 7, wherein the bypass network further comprises:
at least two address registers;
at least two data registers, electrically coupled to the address registers; and
a multiplexer to multiplex data from the data registers.

11. The memory block of claim 7, wherein the bit lines are electrically coupled to at least one function unit.

12. A system, comprising:
at least one functional unit;
at least two memory blocks arranged in a pipeline manner, wherein the memory blocks each include a bypass network, the memory blocks to store operands for the functional unit.

13. The system of claim 12, wherein the memory block further comprises a decoder electrically coupled to the bypass network.

14. The system block of claim 12, wherein the memory block further comprises a content-addressable memory electrically coupled to the decoder.

15. The system block of claim 12, wherein the bypass network further comprises:
at least two address registers;
at least two data registers, electrically coupled to the address registers; and
a multiplexer to multiplex data from the data registers.

16. The system of claim 12, wherein the system further comprises a controller to schedule reads from the memory blocks such that operands are available to the functional unit at an appropriate time.

17. The system of claim 16, wherein the controller further comprises a scheduling function of a system processor.

18. The system of claim 16, wherein the controller further comprises a scheduling function of the functional unit.
